(19) United States
(12) Patent Application Publication
(10) Pub. No.: US 2011/0225215 A1
(43) Pub. Date: Sep. 15, 2011

(54) COMPUTER SYSTEM AND METHOD OF EXECUTING APPLICATION PROGRAM

(75) Inventors: TOSHIYUKI UKAI, Machida (JP); Tsuneo Iida, Yokohama (JP)

(73) Assignee: Hitachi, Ltd.

(21) Appl. No.: 12/796,313

(22) Filed: Jun. 8, 2010

(30) Foreign Application Priority Data
Mar. 12, 2010 (JP) JP2010-055274

(51) Int. Cl. G06F 12/00; G06F 12/02; G06F 17/30

(52) U.S. Cl. 707/821; 711/170; 707/E17.01; 711/E12.001; 711/E12.002

(57) ABSTRACT

It is provided a computer system comprising a storage device storing a file, application computers and a management computer for executing a management program. The management computer manages fragmentation definition information indicating a manner of allocation of data of the file and file management information for managing the state of allocation of the data of the file, and allocates the data of the file stored in the storage device to a distributed memory storage in accordance with the fragmentation definition information. The application computers executes an application program and an access management program. The application computers, by executing the access management program, receives an access to data of the file from the application program, obtains the file management information about the file to be accessed from the management program, and accesses the data allocated to the distributed memory storage on the basis of the file management information.

### CLAIM OF PRIORITY

The present application claims priority from Japanese patent application JP 2010-55274 filed on Mar. 12, 2010, the content of which is hereby incorporated by reference into this application.

### BACKGROUND OF THE INVENTION

The present invention relates to a computer system and a method of executing an application program thereof and, in particular, to a method and a computer system for executing the application program at higher speed.

In recent years, the amount of data to be processed by an application program in a computer system has explosively increased. The increase in the amount of data handled by the computer system increases process time, causing a problem that certain processes like a batch job cannot be finished within an expected time period. To overcome this problem, higher-speed processing has been increasingly required in which multiple servers process massive data in parallel, for example.

In general, existing application programs handle data in file format. Files are used in various ways depending on the application program. Particularly in critical business applications executed by mainframes, COBOL is used as a programming language in designing application programs. Such application programs use files as sets of records.

A record is a fundamental unit of data to be processed by an application program, and an application program inputs and outputs data in units of records. A record contains a series of associated information and the items of the information are referred to as fields. Taking the information handled by banking facilities as an example, information on a transaction corresponds to a record, each item such as an account number, a branch number, and a product code corresponds to a field. An application program reads records from a file to process them sequentially one by one. When data in such a form are processed in parallel using an existing program, the data may be divided into records to be processed. The reason for dividing data is that an application program reads and processes records one by one, so duplicating data and processing them in a plurality of servers do not result in improvement of throughputs in each server.

To divide data into records, the distributed database technology has been known that divides a database into records depending on a key. For example, JP1993-334165A discloses that data in a database are divided into records depending on the key range to execute parallel processing.

Furthermore, the parallel computing technology has been known as a technology regarding parallel data processing that processes massive data with multiple computing nodes to increase the processing speed. For example, JP1995-219905A discloses a technique that divides massive data regularly such as in mesh or with predetermined length and processes the data in parallel with computing nodes to achieve higher-speed processing.

In the meanwhile, to process massive data with multiple servers at higher speed, the distributed memory technology (the distributed cache technology) has been proposed as a basis, for example, which is disclosed in “GemFire Enterprise” in Technical White Paper 2007, GemStone Systems Inc. The distributed memory technology is a technology that integrates memories in a plurality of servers to form a memory space for storing massive data. It is aimed at higher-speed input and output by parallel processing with data distribution and data store in memory.

In the distributed memory technology, the key value data model is employed to distribute massive data to multiple PC servers. The key value data is a data structure in which a key of the identifier of data is associated with a value of the main body of the data and is administrated in the combination [key, value]. The substance of the key value data is an object in the object-oriented data model, and in use of the distributed memory technology, application programs are usually designed in an object-oriented language.

According to the distributed memory technology, data are distributed to a plurality of servers in key-value data model depending on the coverage of a key (the key range) and distributed data are processed in parallel by the servers to increase the processing speed.

For in-memory data, a technology has been known that integrates the memories of a plurality of servers and create a shared device, allowing the same way of data input/output as data input/output to/from a common storage, for example, a disk.

To divide data to be processed and process the divided data in parallel by an existing application program designed in COBOL as a programming language in application of a conventional technique like the one described above, originally existing massive data are to be divided. As a result, a problem that data are difficult in handling occurs; for example, the association between the original massive data and the divided data must be administrated.

Moreover, in a system comprised of a plurality of servers, a file system space is frequently shared using a common file system so that any server can access certain data with a uniquely assigned name to attain the convenience in handing data. In this case, it is necessary to assign unique file names to respective divided data, and in execution environment for an application program, the application program is required to be executed in consideration of a possibility of changing the file name after divide.

In use of the distributed memory technology, an existing application program that inputs and outputs data in units of records cannot be used without modification, and a new application program conformable to key-value data model (object) is required to be developed.

As understood from the above description, the above-described conventional techniques are difficult to accomplish parallel processing for higher speed while using unmodified existing application programs.

### SUMMARY OF THE INVENTION

A representative aspect of this invention is as follows. That is, there is provided a computer system comprising a storage device storing a file, a plurality of application computers each comprising a processor for executing an application program which operates using data of the file and an access management program which receives a request for an access to data of the file from the application program and accesses the data of the file, and a memory device which is accessed by the processor, and a management computer comprising a processor for executing a management program which divides an original file stored in the storage device and allocates the divided file to a distributed memory storage which is configured by integrating memory areas prepared in the memory devices in the plurality of application computers, and a memory device which is accessed to by the processor. The management program manages fragmentation definition information which indicates a manner of allocation of the data of the file to each of the memory areas which constitute the distributed memory storage and file management information for managing the state of allocation of the data of the file to the distributed memory storage, and allocates the data of the file stored in the storage device to the distributed memory storage in accordance with the fragmentation definition information. The plurality of application computers executes the application program and the access management program. The plurality of application computers, by executing the access management program, receives an access to data of the file from the application program, obtains the file management information about the file to be accessed from the management program, and accesses the data allocated to the distributed memory storage on the basis of the file management information.

According to this invention, in a computer system comprised of a plurality of computers, parallel processing for higher processing speed is accomplished without modification of existing application programs.

### BRIEF DESCRIPTION OF THE DRAWINGS

The present invention can be appreciated by the description which follows in conjunction with the following figures, wherein:

FIG. 1 is a block diagram showing a simplified system configuration of a computer system according to an embodiment of this invention;

FIG. 2 is a explanatory diagram showing a configuration of record definition information according to the embodiment of this invention;

FIG. 3 is an explanatory diagram of program source codes showing an example of the source program of the UAP according to the embodiment of this invention;

FIG. 4 is an explanatory diagram showing a configuration of fragmentation definition information according to the embodiment of this invention;

FIG. 5 is an explanatory diagram showing a configuration of persistent storage and distributed memory storage association information according to the embodiment of this invention;

FIG. 6 is an explanatory diagram showing a configuration of distributed memory storage configuration information according to the embodiment of this invention;

FIG. 7 is an explanatory diagram showing a configuration of distributed memory storage management information according to the embodiment of this invention;

FIG. 8 is an explanatory diagram showing a configuration of file management information in the distributed memory storage according to the embodiment of this invention;

FIG. 9 is an explanatory diagram showing the assignment information in the case that a file is normally allocated in the distributed memory storage according to the embodiment of this invention;

FIG. 10 is an explanatory diagram showing the assignment information in the case that a file is allocated in fragments in the distributed memory storage according to the embodiment of this invention;

FIG. 11 is an explanatory diagram showing a configuration of fragment configuration information according to the embodiment of this invention;

FIG. 12 is an explanatory diagram showing a configuration of open file information according to the embodiment of this invention;

FIG. 13 is a flowchart showing a process of loading a file by using the pull loading method according to the embodiment of this invention;

FIG. 14 is a flowchart showing a process of loading a file by using the push loading method according to the embodiment of this invention;

FIG. 15 is a flowchart showing a process of opening a file in the case that the push type is assigned to the loading method according to the embodiment of this invention;

FIG. 16 is a flowchart illustrating an input/output process from/to a file allocated in the distributed memory storage according to the embodiment of this invention;

FIG. 17 is a flowchart illustrating a read process of data from a file allocated in fragments in the distributed memory storage according to the embodiment of this invention;

FIG. 18 is a flowchart illustrating a write process of data to a file allocated in fragments in the distributed memory storage according to the embodiment of this invention;

FIG. 19 is a flowchart illustrating a process of unloading a file allocated in fragments in the distributed memory storage according to the embodiment of this invention; and

FIG. 20 is a conceptual diagram exemplifying a configuration of a file, which is an object to be processed according to the embodiment of this invention.

### DETAILED DESCRIPTION OF THE EMBODIMENTS

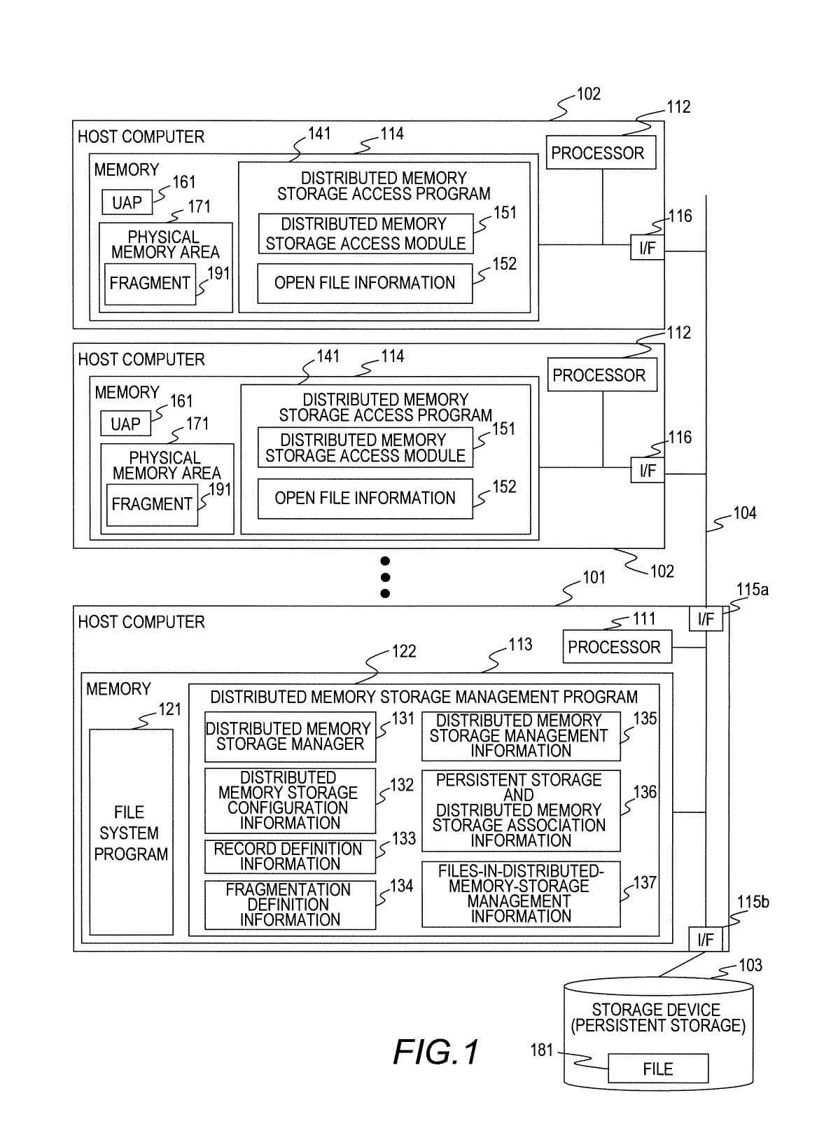

FIG. 1 is a block diagram showing a simplified system configuration of a computer system according to an embodiment of this invention.

The computer system according to this embodiment comprises a host computer 101, a plurality of host computers 102, and a storage device 103. The host computer 101 is connected to the host computers 102 via a network 104. In this embodiment, the storage device 103 is a storage device for persistently storing files to be processed, although the storage device may be any kind of storage device such as a non-volatile semiconductor disk device employing a flash memory as a storage medium, or an optical device, as far as it can store data persistently.

The host computer 101 comprises a processor 111, a memory 113, and interfaces (I/Fs) 115, which are interconnected. The host computer 101 is interconnected with the storage device 103 via an interface (I/F) 115b and with the host computers 102 via an interface (I/F) 115a.

The memory 113 stores a file system program 121 and a distributed memory storage management program 122. The file system program 121 manages files 181, which are data stored in the storage device 103, and inputs and outputs data to and from a file 181 as necessary. In this embodiment, the whole system shares a common file namespace. The file system program 121 provides a function to access a file 181 with a name unique in the whole system. A file 181 stored in the storage device 103 can be accessed from the programs running on the host computer 101 and the host computers 102 via the file system program 121.

The distributed memory storage management program 122 is a program for managing a later-described distributed memory storage. The distributed memory storage management program 122 comprises a distributed memory manager 131 of a main module of the program for implementing functions to manage the distributed memory storage, distributed memory storage configuration information 132, which is information to be used by the distributed memory manager 131, record definition information 133, fragmentation definition information 134, distributed memory storage management information 135, persistent storage and distributed memory storage association information 136, and files-in-distributed-memory-storage management information 137.

In this embodiment, the processor 111 executes these programs stored in the memory 113 to implement the later-described functions of the host computer 101. The memory 113 is, for example, a semiconductor memory like a DRAM, and can be accessed faster than the storage device 103 is. It is not necessary that the file system program 121, the distributed memory storage management program 122, and other programs and data be located in the memory 113 all the time, but they may be stored in the storage device 103 or an external storage device which is not shown in the drawings, and all of them or part of them may be copied into the memory 113 as necessary.

Each host computer 102 comprises a processor 112, a memory 114, and an interface (I/F) 116, which are interconnected. A host computer 102 is connected with the host computer 101 and other host computers 102 via the interface 116. In this embodiment, the host computers 102 have the same configuration, but it is not necessary that they have the same configuration, as far as the following functions or processes can be executed.

In a memory 114, a distributed memory storage access program 141 and a user application program (UAP) 161 which operates using data stored in a file 181 are stored. Like the host computer 101, the processor 112 executes these programs to implement the later-described functions of the host computer 102. Like the memory 113, the memory 114 is, for example, a semiconductor memory like a DRAM, and can be accessed by the processor 112 faster than the storage device 103 is. It is not necessary that the programs and the data to be stored in the memory 114 all the time, but they may be stored in an external storage device (not shown) like an auxiliary disk device, and all of them or part of them may be copied into the memory 114 as necessary. In the memory 114, a physical memory area 171 is prepared that constitutes a part of the storage area of the distributed memory storage.

The distributed memory storage access program 141 manages the physical memory area 171 and controls the access to the distributed memory storage configured by the physical memory areas 171 prepared in the memories 114 of the local host computer and other host computers. The distributed memory storage access program 141 comprises a distributed memory storage access module 151, which is a main module of the program for controlling the access to the distributed memory storage, and open file information 152, which is management information to be used by the distributed memory storage access module 151 to access the distributed memory storage.

In a physical memory area 171, a fragment 191 of data which constitute a part of a file (not shown) stored in the distributed memory storage is stored. In this embodiment, the distributed memory storage is configured by integrating the physical memory areas 171 in the host computers 102. The host computers 101 and 102 can access the distributed memory storage like a shared device. Placing data required for processing in the distributed memory storage and using them increase the speed of input and output operations, compared with using data stored in the storage device 103.

The above-described file system program 121 and the distributed memory storage management program 122 may be provided as a part of an operating system (OS) (not shown) or an input and output library to be used by a user application program (not shown). The distributed memory storage management program 122 manages the configuration and the state of use of the distributed memory storage in cooperation with the distributed memory storage access programs 141 in the host computers 102 to control loading data from the storage device 103 to the distributed memory storage and unloading data from the distributed memory storage to the storage device 103.

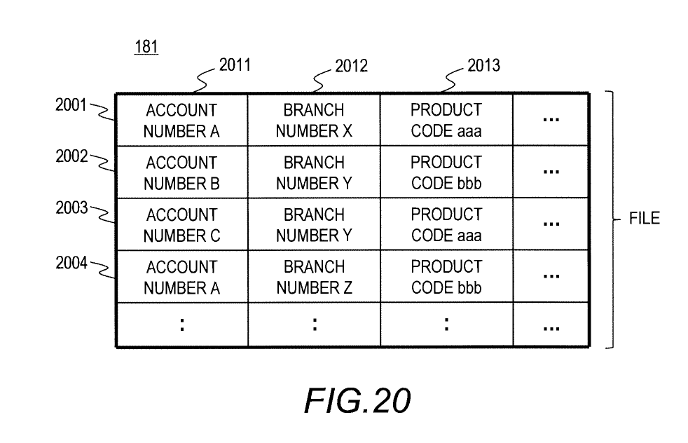

FIG. 20 is a conceptual diagram exemplifying a configuration of a file, which is an object to be processed in this embodiment.

A file 181 is configured to have a plurality of records 2001, 2002, 2003, 2004 . . . , which are the units of data to be processed by the UAP 161. The records 2001, 2002, 2003, 2004 . . . each contains a plurality of fields 2011, 2012, 2013 . . . , which include a series of associated information. Although FIG. 20 shows four records, a file may contain desired number of records and one record may contain any number of fields within the range restricted by the system. For example, in the case of data used in the product transaction business, a record is comprised of transaction information for one transaction, and separate information (data) such as an account number, a branch number, a product code, and the like are recorded in a field.

A UAP 161 inputs and outputs data in units of records. The UAP 161 processes data by inputting and outputting records one by one to and from a file sequentially in order from the beginning of the file. In this embodiment, a file 181 is divided in units of records in accordance with a key, which is a field in a record, so as to be conformable to processes performed by the UAP 161. The divided portions of the file 181 are assigned to the respective UAPs 161 of a plurality of host computers 102 and processed in parallel by the plurality of UAPs. In this way, reducing the amount of data to be processed by a UAP 161 and executing a plurality of UAPs in parallel can increase the processing speed.

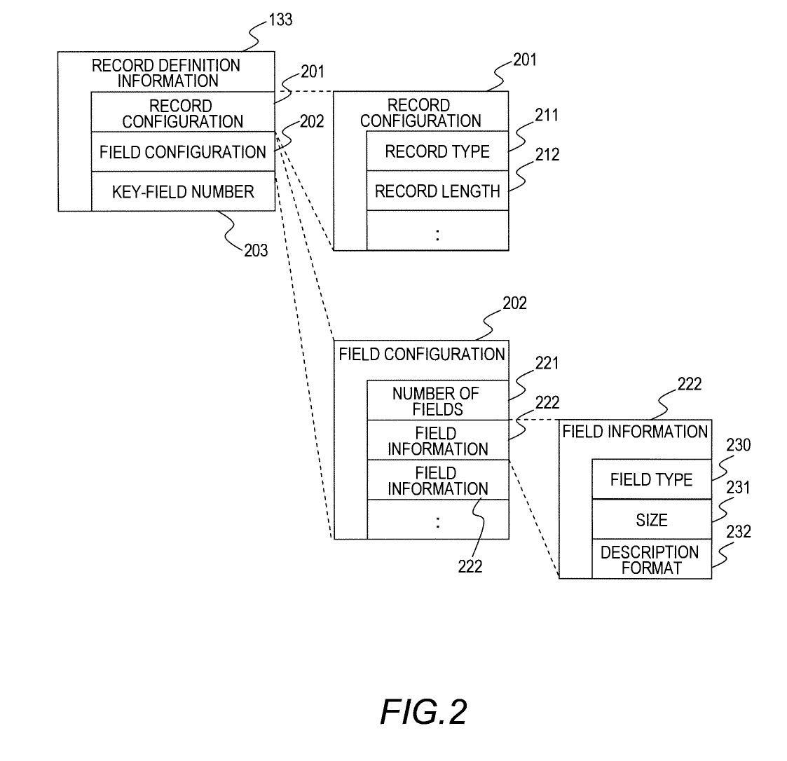

FIG. 2 is an explanatory diagram showing a configuration of record definition information 133. The record definition information 133 is information to be used to recognize records in a file and to divide the file into records. The record definition information 133 comprises the record configuration 201, the field configuration 202, and the key-field number 203. In this embodiment, the record definition information 133 is set on every file to be stored in the storage device 103.

The record configuration 201 is information for identifying the record configuration in a file 181, including the record type 211 and the record length 212. The record type 211 is information that indicates whether records in a file 181 are fixed-length records or variable-length records. If the record type 211 indicates the fixed-length record, the file 181 includes records having the same predetermined length. If the record type 211 indicates the variable-length record, the records that constitute the file 181 have different lengths. The record length 212 is information that indicates the length of a record, if the record type 211 indicates the fixed-length record. The field configuration 202 is information for characterizing the field in a record, including the number of fields 221 which indicates the number of fields included in a record and field information 222 associated with each field. The field information 222 is information about the data to be recorded in the associated field, including the field type 230, the size 231, and the description format 232. The field type 230 is information that indicates whether the associated field is a variable-length field or a fixed-length field, if the record type 211 indicates the variable-length record. The size 231 indicates the length of the associated field if the field type 230 indicates the fixed-length field, and indicates the size of the area in the record storing the information indicating the length of the field if the field type 230 indicates the variable-length field. The description format 232 indicates the description format of the data recorded in the associated field, such as ASCII, binary, or the like. The key-field number 203 is information that indicates which field in a record should be used as the key in dividing a file 181.

If a file 181 consists of fixed-length records, individual records can be recognized with the value set on the record length 212. On the other hand, if a file 181 consists of variable-length records, a field for recording the size of a record is provided at the beginning of each record. The boundary between records can be determined by the field for recording the size of a record. In the case of variable-length records, the information set on the field configuration 202 allows the first field of a record to be located so that the record size can be obtained. After a record is recognized, fields are identified by referring to the number of fields 221 and the field size 222 in the field configuration 202.

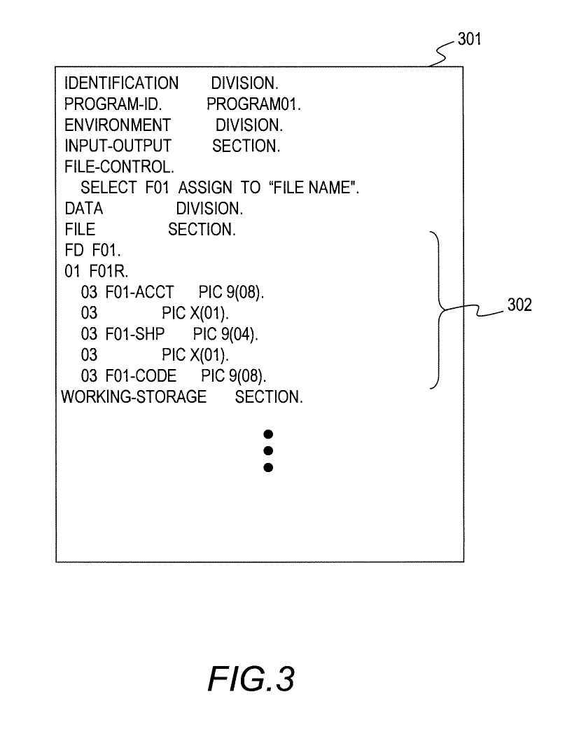

FIG. 3 is an explanatory diagram of program source codes showing an example of the source program of the UAP 161 in this embodiment.

In this embodiment, the UAP 161 is described in COBOL language. A COBOL program defines the configuration of a record of a file within the program. The source program 301 shown in FIG. 3 is an example of a program described in COBOL language, and the configuration of data files is defined in the FILE SECTION 302 of the DATA DIVISION. The record configuration of each file to be used by the program is defined in one entry of file description (FD) and subsequent one or more record description sections. In this embodiment, the record configuration 201 and the field configuration 202 in the record definition information 133 can be set using the information described in the FILE SECTION 302.

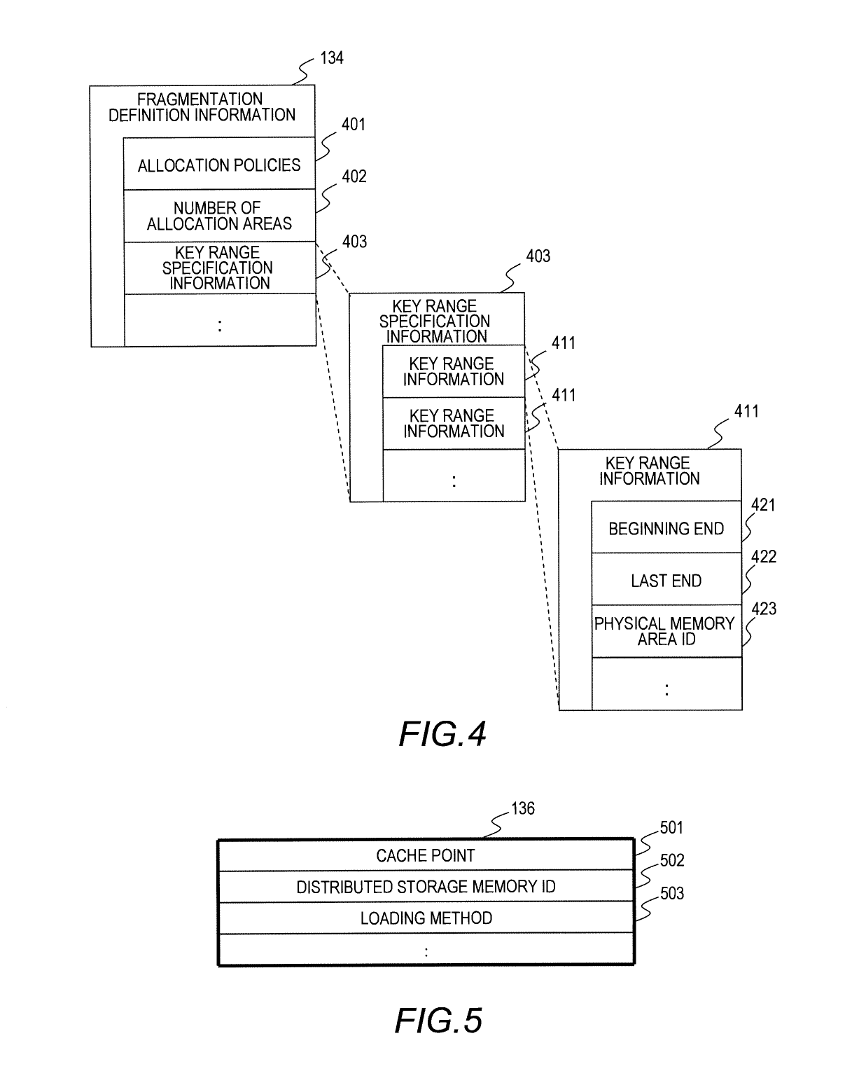

FIG. 4 is an explanatory diagram showing a configuration of fragmentation definition information 134. The fragmentation definition information 134 is used in determining the manner of allocation of the divided fragments when dividing a file 181 and allocating it in fragments into the physical memory areas 171 of the host computers 102 that constitute the distributed memory storage. The process will be described later. The fragmentation definition information 134 includes information such as allocation policies 401, the number of allocation areas 402, key range specification information 403, and the like.

The allocation policies 401 are information that specifies the divide policy for a file 181, such as “key range specification”, “use volume leveling with sorting”, “use volume leveling without sorting”, and the like. The “key range designation” means to divide a file 181 according to the information set on the key range specification information 403, which will be described later, and to allocate the records in the divided portions of the file 181 to the distributed memory storage. The “use volume leveling with sorting” means to sort the records in accordance with the data of the field designated by the key-field number 203 and distribute the records so as to be allocated in such a manner that the number of records will be leveled among the physical memory areas 171 which constitute the distributed memory storage. The “use volume leveling without sorting” means to allocate the records without sorting them, unlike the “use volume leveling with sorting”.

The number of allocation areas 402 is information that indicates how many physical memory areas 171 where the fragments of a file 181 are allocated should be prepared in allocating the file in fragments.

The key range specification information 403 includes a plurality of pieces of key range information 411. Each piece of key range information 411 includes the beginning end 421 of the key, the last end 422 thereof, and a physical memory area ID 423. The key range information 411 is information that indicates to which physical memory area 171 records belonging to the range defined by a beginning end 421 and a last end 422 should be allocated.

FIG. 5 is an explanatory diagram showing a configuration of persistent storage and distributed memory storage association information 136. The persistent storage and distributed memory storage association information 136 is information for associating a file 181 contained in the storage device 103 and a file in the distributed memory storage. The persistent storage and distributed memory storage association information 136 includes the cache point 501, the distributed memory storage ID 502, and the loading method 503.

The cache point 501 is information for specifying a directory or a file to be cached, namely allocated in the distributed memory storage, in the file namespace in the whole system provided by the file system program 121. If a directory is specified by the cache point 501, the file in the specified directory is the object of the cache. The distributed memory storage ID 502 is information that specifies the distributed memory storage to which the specified directory or file specified by the cache point 501 is allocated. The loading method 503 is information that indicates the trigger event of loading the directory or the file specified by the cache point 501 to the distributed memory storage specified by the distributed memory storage ID 502. On the loading method 503, “push” or “pull” is set. If “push” is set on the loading method 503, a file is preloaded into the distributed memory storage by declaring the use of the file before executing the application program that uses the file. If “pull” is set on the loading method 503, the file is loaded into the distributed memory storage when the target file is opened.

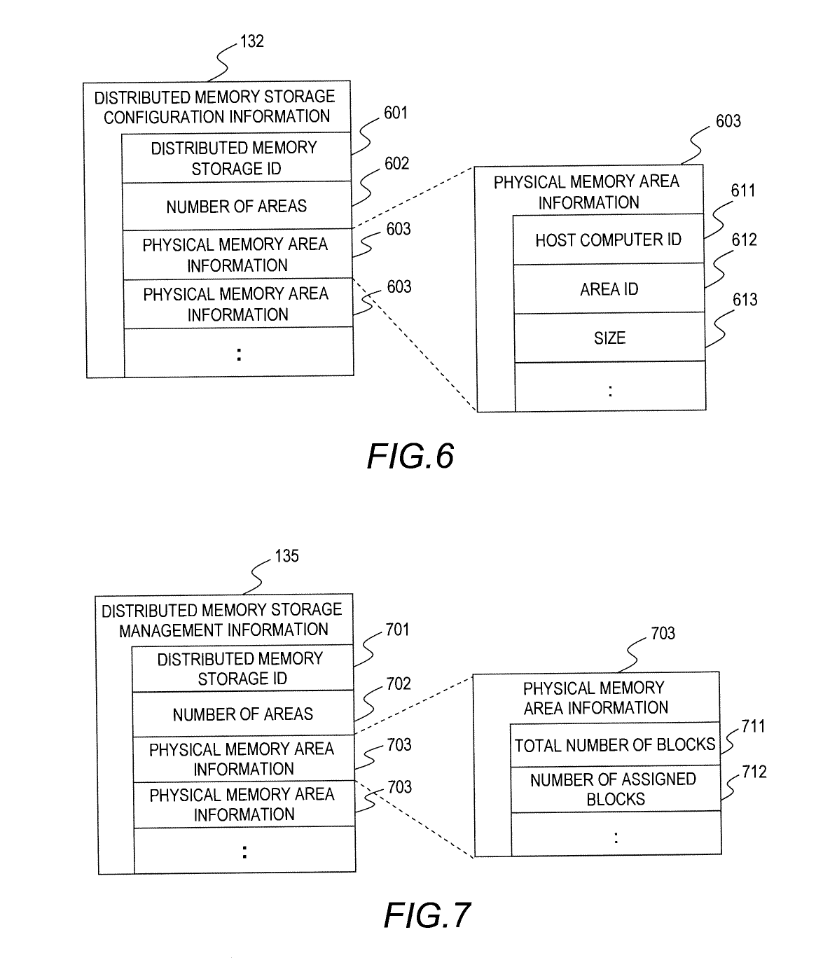

FIG. 6 is an explanatory diagram showing a configuration of distributed memory storage configuration information 132. The distributed memory storage configuration information 132 is information that indicates the relationship between the distributed memory storage and physical memory areas 171 that constitute the distributed memory storage. The distributed memory storage configuration information 132 includes a distributed memory storage ID 601 for identifying the distributed memory storage, the number of areas 602, and physical memory area information 603.

The number of areas 602 is information that indicates the number of physical memory areas 171 which constitute the distributed memory storage. The physical memory area information 603 is information concerning a physical memory area which is a part of the distributed memory storage, such as information for identifying the physical memory area 171 which is a part of the distributed memory storage, the size of the physical memory area 171, and the like. The physical memory area information 603 includes a host computer ID 611, a physical memory area ID 612, and the size of the physical memory area 613. The host computer ID 611 is information for identifying the host computer 102 possessing the physical memory area 171 that is a part of the distributed memory storage. As far as individual host computers 102 can be identified in the system, any kind of information may be used for the host computer ID 611; a host name uniquely assigned in the system or an IP address associated with the network interface of a host computer 102 may be used. The area ID 612 is information for identifying a physical memory area 171 assigned to be a part of the distributed memory storage which is identified by the distributed memory storage ID 601, if a plurality of memory areas are prepared within a host computer 102. Although the area ID 612 may be any kind of information as far as a physical memory area can be uniquely identified, a physical address is used in this description.

FIG. 7 is an explanatory diagram showing a configuration of distributed memory storage management information 135. The distributed memory storage management information 135 is used for managing information that dynamically varies like the status of use of the distributed memory storage. The distributed memory storage management information 135 includes the distributed memory storage ID 701 for identifying the distributed memory storage, the number of areas 702, and physical memory area information 703.

The number of areas 702 is information that indicates the number of physical memory areas 171 which constitute the distributed memory storage identified by the distributed memory storage ID 701. The physical memory area information 703 is information that indicates the status of use of the physical memory area which is identified by the information set on the physical memory area information 603 located at the corresponding place in the distributed memory storage configuration information 132. The physical memory area information 703 includes the total number of blocks 711, the number of assigned blocks 712, and the like. In this description, a block is a storage area having a preset size as a management unit for a physical memory area and the distributed memory storage area. The distributed memory storage manager 131 manages a file arranged in the distributed memory storage in units of blocks. The total number of blocks 711 indicates the total number of blocks included in the physical memory area 171 which is identified by the physical area information 603 corresponding to the physical area information 703 which includes the total number of blocks 711. The number of assigned blocks 712 indicates the number of blocks in actual use in the blocks included in the physical memory area 171 which is identified by the physical area information 603 corresponding to the physical area information 703 including the number of assigned blocks 712.

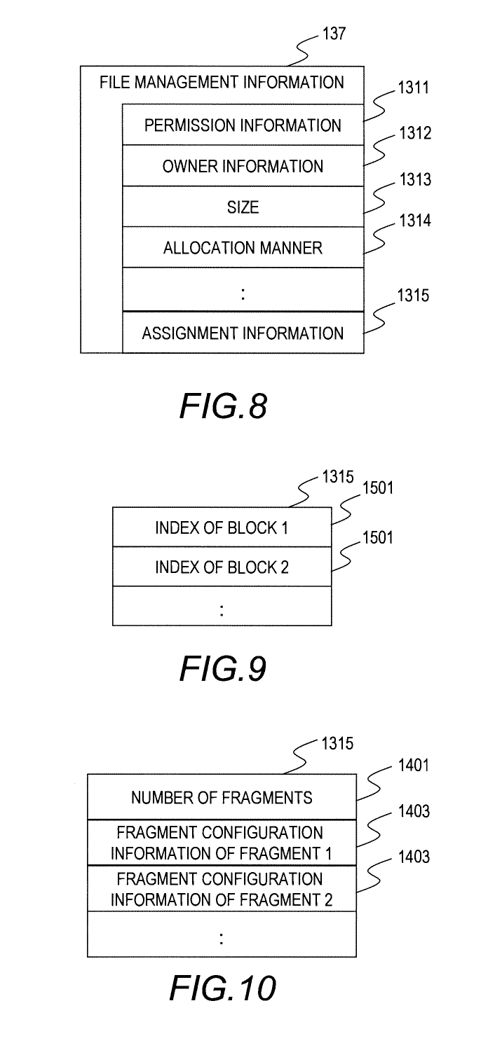

FIG. 8 is an explanatory diagram showing a configuration of file management information 137 in the distributed memory storage. The files-in-distributed-memory-storage management information 137 is information created for the files existing in the distributed memory storage, and is information for managing files allocated in the distributed memory storage. The files-in-distributed-memory-storage management information 137 includes permission information 1311 indicating the right of access to the file, owner information 1312 indicating the user who owns the file, the size 1313 indicating the size of the file, allocation manner 1314 indicating the manner of file allocation to the distributed memory storage, assignment information 1315 indicating the assignment of blocks, which are the units for management in the distributed memory storage, to the file, and the like. They are set in loading a file into the distributed memory storage, which will be described later.

In the allocation manner 1314, the allocation manner of a file allocated in the distributed memory storage is set. In this embodiment, the allocation manner of a file is “in fragments” or “normal”. As for the “in fragments”, a file is divided into a plurality of fragments and distributed to the physical memory areas 171 in a plurality of host computers 102 (hereinafter, such a file allocation is referred to as “allocation in fragments”). As for the “normal”, a file is allocated in the physical memory areas 171 in a plurality of host computers 102 without being divided into a plurality of fragments (hereinafter, such a file allocation is referred to as “normal allocation”). On the allocation manner 1314, information indicating “in fragments” or “normal” is set according to the manner of allocation. The information to be set on the assignment information 1315 differs depending on whether a file is allocated to the distributed memory storage “in fragments” or not. Hereinafter, the assignment information 1315 will be described.

FIG. 9 is an explanatory diagram showing the assignment information 1315 in the case that a file is normally allocated in the distributed memory storage. In the normal allocation, the distributed memory storage configured by a plurality of physical memory areas is treated as if it were a single memory area.

In this embodiment, a physical memory area 171 is managed in units of blocks having a certain size in order to make the management simpler. If a file is not fragmented, the file is assigned to the blocks determined on one-to-one basis to the offsets in the file, as in the case of usual storing of a file to the storage device 103. To the assignment information 1315, indexes 1501 for identifying the blocks which have been assigned to store the file are set sequentially in order from the block storing the beginning of the file. Alternatively, the area for storing file data may be managed in terms of the extent of the offset and the size.

FIG. 10 is an explanatory diagram showing the assignment information 1315 in the case that a file is allocated in fragments in the distributed memory storage.

The assignment information 1315 of a fragmented file is information that indicates the assignment of blocks to a file allocated in fragments in the distributed memory storage.

The number of fragments 1401 is information that indicates number of fragments of the divided file. This number is the same as the number which is specified for the number of allocation areas 402 in the fragmentation definition information 134 described with reference to FIG. 4. When a file is divided and distributed into the physical memory areas 171 of a plurality of host computers 102, the data in the file are first associated with divided fragments and the associated data are then associated with the blocks in the physical memory areas 171 assigned to the fragments. In other words, a block in a physical memory area 171 for storing data in a file is assigned to data in the file in two steps. Fragment configuration information 1403 includes information concerning blocks in a physical memory area 171 to which a fragment is assigned, with respect to each divided fragment of a file.

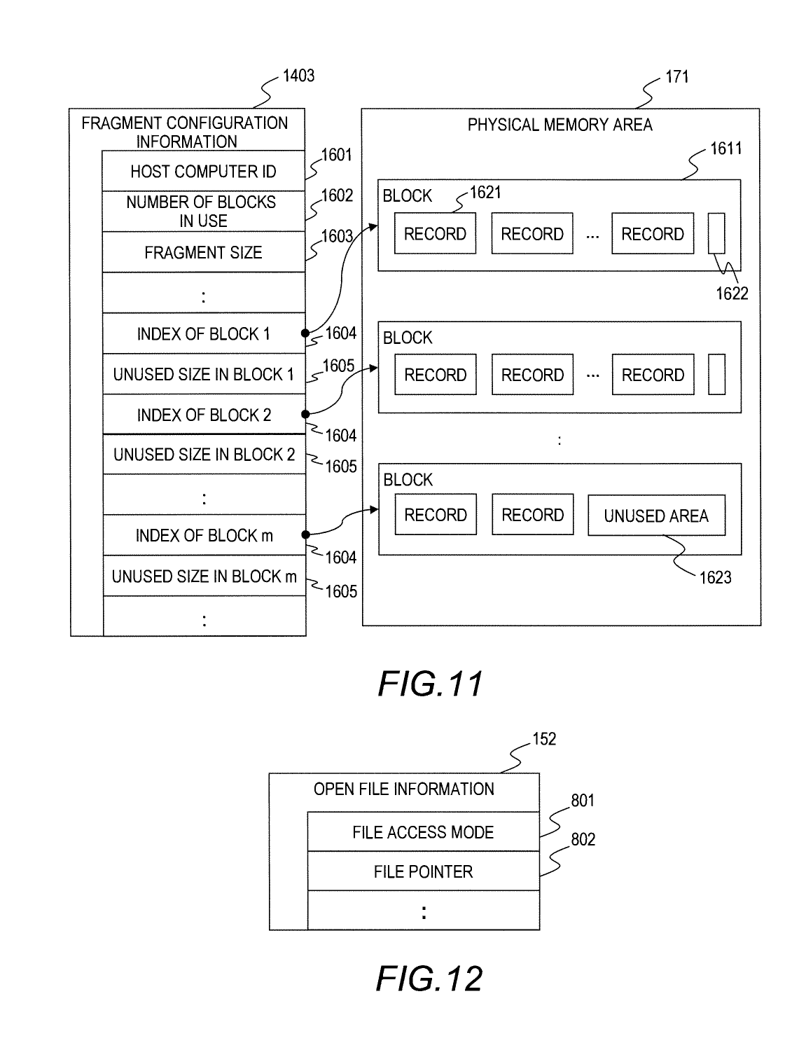

FIG. 11 is an explanatory diagram showing a configuration of fragment configuration information 1403. The fragment configuration information 1403 includes the host computer ID 1601, the number of blocks in use 1602, the fragment size 1603, and a plurality pairs of the index of block 1604 and the unused size in block 1605.

The host computer ID 1601 is information for identifying the host computer 102 including the physical memory area 171 which is assigned to store the file fragment corresponding to the fragment configuration information 1403. The number of blocks in use 1602 is information that indicates the number of blocks in the physical memory area 171 assigned to store the corresponding file fragment. The fragment size 1603 is information that indicates the size of the corresponding file fragment. The block index 1601 is information for identifying the block which is assigned to store the file fragment corresponding to the fragment configuration information 1403, and the unused size 1605 is information that indicates the size of the unused area which is not used for storing records of a file in the block.

Since a file allocated in the distributed memory storage is used in units of records, it is stored in units of records 1621 in a block 1611 within a physical memory area 171 as shown in FIG. 11. Usually, the boundary of a block 1611 does not agree with the boundary of a record 1621, so that an unused area 1622 smaller than a record 1621 is yielded. The size of this unused area is stored as the unused size 1605 in every block. Furthermore, at the last end of a file fragment, an unused area 1623 is similarly yielded. The unused area 1623 yielded at the last end of a file fragment is also managed as the unused size 1605 in the block in the same manner. Such fragment configuration information 1403 becomes necessary under the conditions that a distributed memory storage access module 151 directly receives an input/output request in units of records. If the input/output request to be received by the distributed memory storage access module 151 is buffered in a process at a middle of a library layer, the management of unused area size is not required and whether the data which constitute a record is located over another block is not necessary to be noted. In such a case, the unused size 1605 in a block in the fragment configuration information 1403 becomes unnecessary.

FIG. 12 is an explanatory diagram showing a configuration of open file information 152. The open file information 152 is information managed by the distributed memory storage access program 141, and is information about a file which is stored in the distributed memory storage and is opened by the host computer 102. The open file information 152 includes the file access mode 801 and the file pointer 802. The open file information 152 includes the file access mode 801 and the file pointer 802.

On the file access mode 801, an access mode, which is determined depending on the manner of file allocation to the distributed memory storage, is set in an open process by the distributed memory storage access program 141. That is, if a file is allocated in fragments, “in fragments” is set on the file access mode 801; and if the file is arranged normally, “normal” is set. If the file access mode 801 is “normal”, the UAP 161 inputs or outputs a file sequentially in order from the first record of the file. On the other hand, if the file access mode 801 is “in fragments”, each UAP 161 inputs records to or outputs records from a file by inputting or outputting records sequentially in order from the first record of a file fragment contained in each physical memory area 171 of each host computer 102.

The file pointer 802 is information that indicates the beginning of a record subjected to read or write by a file access. If the file access mode 801 is “normal”, information indicating the beginning of the record next to the record read or written in inputting or outputting a file is set in the file pointer 802. If the file access mode 801 is “in fragments”, information indicating the beginning of the record to be read or written in the next access is set by a positioning process to the beginning of a record, which will be described later.

The fragmentation definition information 134, the file management information 137, and the open file information 152 are stored for every file to be used. Although particularly not shown in the drawings, they may include information for identifying the file, such as a file name or a file ID, to make it possible to identify which file the information is associated with.

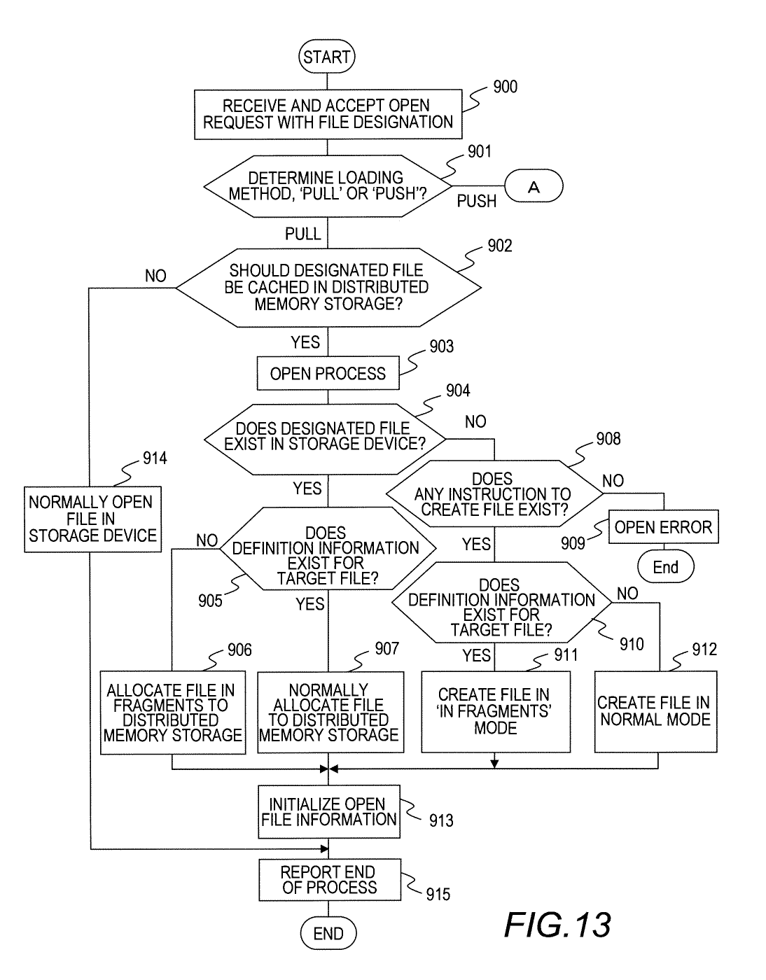

FIG. 13 is a flowchart showing a process of loading a file in accordance with the pull loading method. When the UAP 161 in a host computer 102 issues a request for opening a file, the distributed memory storage access modules 151 in the distributed memory storage access programs 141 and the distributed memory storage manager 131 execute the loading process.

If a UAP 161 in a host computer 102 issues an open request with designation of a file, the distributed memory storage access module 151 receives and accepts the request. The open request received by the distributed memory storage access module 151 is sent to the distributed memory storage manager 131 in the host computer 101 (step 900).

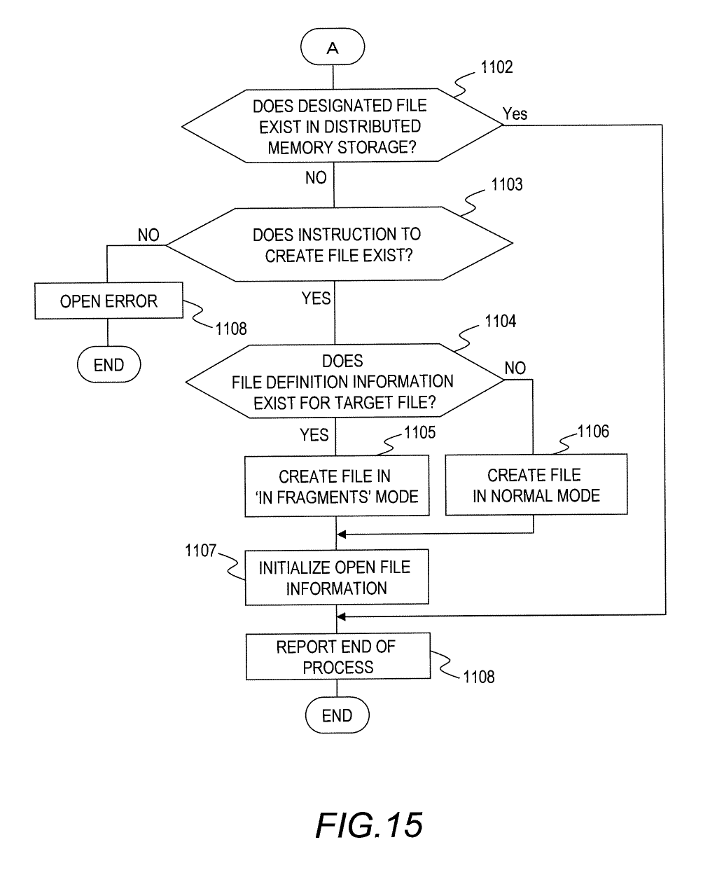

If the distributed memory storage manager 131 receives the open request, it determines whether the loading method preset on the loading method 503 in the persistent storage and distributed memory storage association information 136 is “pull” or “push”. If the preset loading method is “push”, an open process shown in FIG. 15 is executed (step 901).

If the loading method “pull” is preset on the loading method 503 in the persistent storage and distributed memory storage association information 136, the distributed memory storage manager 131 further refers to the persistent storage and distributed memory storage association information 136 and determines whether the file designated by the open request should be cached to the distributed memory storage or not. This determination is made by checking whether the file designated by the open request is designated as a file to be cached by the cache point 501 in the persistent storage and distributed memory storage association information 136 (step 902).

If it is determined that the file designated by the open request is designated as an object for caching in the step 902, the distributed memory storage manager 131 requests the file system program 121 to open the file designated by the open request received from the UAP (step 903). If the distributed memory storage manager 131 receives a response to the request for opening the file from the file system program 121, it is determined whether the designated file exists in the storage device 103 or not on the basis of the response from the file system program 121 (step 904). In the step 904, if it is determined that the file exists in the storage device 103, the distributed memory storage manager 131 further determines whether record definition information 133 and fragmentation definition information 134 exist or not for the file designated by the open request (step 905).

If it is determined that the record definition information 133 and the fragmentation definition information 134 exist for the file designated by the open request in the step 905, the distributed memory storage manager 131 refers to the record definition information 133 to figure out the record configuration of the file, and reads the file data from the storage device 103 through the file system program 121. The distributed memory storage manager 131 divides the file read out according to the definition in the fragmentation definition information 134, and distributes the data of the divided file fragments for allocation over the distributed memory storage via the distributed memory storage access modules 151. The distributed memory manager 131 creates a file management information 137, sets “in fragments” to the allocation manner 1314, and sets the assignment information 1315 in accordance with the allocation of the file data (step 906).

In the step 905, if it is determined that record definition information 133 and fragmentation definition information 134 do not exist for the file designated by the open request, the distributed memory manager 131 does not divide the file and places it into the distributed memory in the “normal” mode. Specifically, the distributed memory manager 131 refers to distributed memory configuration information 132 and sequentially allocates data to physical memory areas which constitute the distributed memory via the distributed memory storage access modules 151 of the host computers 102 which own the physical memory areas. On this occasion, the distributed memory storage manager 131 creates file management information 137, sets “normal” on the allocation manner 1314, and sets the assignment information 1315 in accordance with the allocation of the file data (step 907).

On the other hand, in the step 904, if it is determined that the file does not exist in the storage device 103, the distributed memory storage manager 131 determines whether it is instructed to create a new file or not (step 908). If it is not instructed to create a new file, the distributed memory storage manager 131 notifies an “open error” to the source of the open request, and the process ends (step 909).

In the step 908, if it is determined that the distributed memory storage manager 131 is instructed to create a new file, it is determined whether record definition information 133 and fragmentation definition information 134 exist or not for the designated file (step 910). If the distributed memory storage manager 131 determines that the record definition information 133 and the fragmentation definition information 134 exist, file management information 137 is created and “in fragments” is set on the allocation manner 1314 (step 911). If the distributed memory storage manager 131 determines that the record definition information 133 and the fragmentation definition information 134 do not exist, file management information 137 in which “normal” is set on the allocation manner 1314 is created (step 912).

After the steps 906, 907, 911, and 912, each distributed memory storage access module 151 initializes the open file information 152. If the file is allocated in fragments, “in fragments” is set on the file access mode 801; and if the file is normally allocated, “normal” is set. On the file pointer, if the file is allocated in fragments, information indicating the beginning of the file fragment in the physical memory area owned by each host computer is set; and if the file is normally arranged, information indicating the beginning of the file in the distributed memory storage is set. The information to be set in this step may be the information notified together with the data allocation by the distributed memory storage manager 131 in the steps 906, 907, 911, and 912 (step 913).

In the step 902, if it is determined that the file designated by the open request is not designated as an object for caching, the distributed memory storage manager 131 opens the file as it normally opens a file stored in the storage device 103 (step 914).

After the above-described steps, the distributed memory storage manager 131 reports the end of the process to the UAP 161 which requested the process via the distributed memory storage access module (step 915).

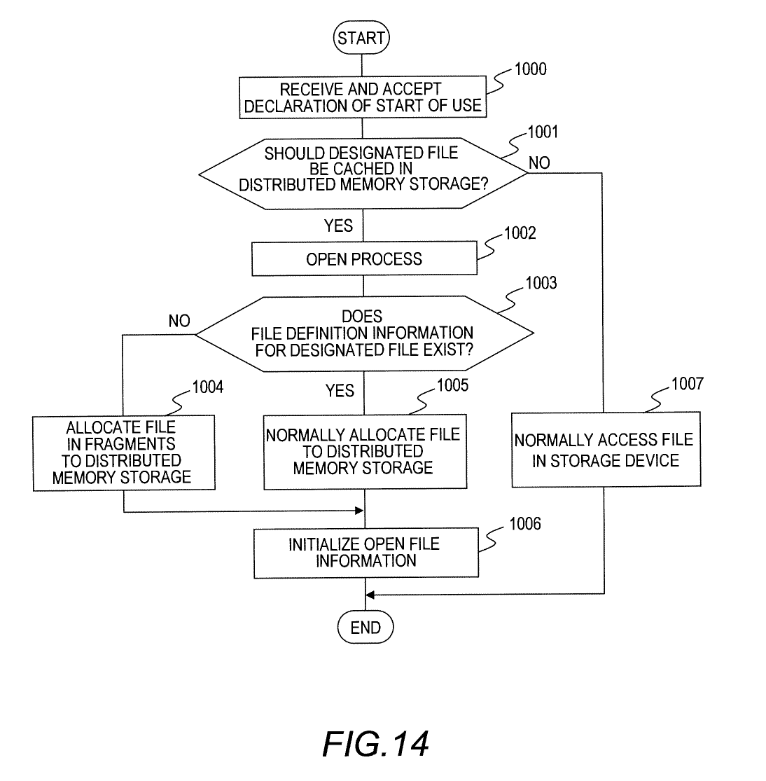

FIG. 14 is a flowchart showing a process of loading a file in accordance with the push loading method. This process is executed by the distributed memory storage manager 131, and the distributed memory storage access module 151 if “push” is preset on the loading method 503 in the persistent storage and distributed memory storage association information 136. According to the push loading method, a file to be used by the UAP 161 is preloaded to the distributed memory storage before the execution of the UAP 161 in the host computer 102. This preloading is executed when the start of use of a file is declared as a trigger event using a dedicated command inputted by the user or issued by a job control program or the UAP, for example.

When a declaration of start of use with a file designation is issued before starting execution of a UAP 161, the distributed memory storage access module 151 or the distributed memory storage manager 131 receives and accepts the issued declaration of start of use. If the distributed memory storage access module 151 accepts the declaration of start of use, it sends the declaration to the distributed memory storage manager 131 (step 1000). When the distributed memory storage manager 131 receives the declaration of start of use, it is determined whether the designated file is to be cached to the distributed memory storage or not in the same manner as in the step 902 (step 1001).

If it is determined that the designated file is to be cached to the distributed memory storage in the step 1001, the distributed memory storage manager 131 requests the file system program 121 to open the file designated by the declaration of start of use in order to read out the file contained in the storage device 103 and allocate it to the distributed memory storage (step 1002). When the distributed memory storage manager 131 receives a response to the request from the file system program 121, it determines whether record definition information 133 and fragmentation definition information 134 exist or not for the designated file (step 1003). In the step 1003, if it is determined that record definition information 133 and fragmentation definition information 134 exist for the designated file, the distributed memory storage manager 131 allocates the designated file to the distributed memory storage in fragments and creates file management information 137 (step 1004). On the other hand, in the step 1003, if it is determined that record definition information 133 and fragmentation definition information 134 do not exist for the designated file, the distributed memory storage manager 131 allocates the designated file in the normal mode and creates file management information 137 (step 1005).

In the step 1001, if it is determined that the file is not designated as an object for caching, the distributed memory storage manager 131 treats the declaration of start of use as a normal access to a file in the storage device 103 (step 1007).

According to the above-described loading process, the designated file in the files contained in the storage device 103 can be allocated to the distributed memory storage in response to a request from the UAP 161 or prior to the execution of the UAP 161.

FIG. 15 is a flowchart showing a process of opening a file in the case that the push type is assigned to the loading method. This process is executed if it is determined that “push” is assigned to the loading method 503 in the persistent storage and distributed memory storage association information 136 in the step 901 of the opening process shown in FIG. 13.

The distributed memory storage manager 131 determines whether the file designated by the received open request exists in the distributed memory storage or not. This determination can be made depending on whether file management information 137 has been created for the designated file or not. If the file management information 137 has been created, it means that the file data has been allocated to the distributed memory storage in accordance with the above-described push-type loading process (step 1102). If the designated file exists in the distributed memory storage, the distributed memory storage manager 131 informs the UAP of the end of the process via the distributed memory storage access module and ends the process (step 1108).

On the other hand, if it is determined that the designated file does not exist in the distributed memory storage in the step 1102, the distributed memory storage manager 131 determines whether the creation of the file is instructed or not (step 1103). If the creation of the file is not instructed, the distributed memory storage manager 131 notifies an “open error” to the UAP 161 via the distributed memory storage access module 151 and ends the process (step 1108).

In the step 1103, if it is determined that the creation of the file is instructed, the distributed memory storage manager 131 determines whether record definition information 133 and fragmentation definition information 134 exist for the designated file (step 1104). If it determines that the record definition information 133 and the fragmentation definition information 134 exist for the file, the distributed memory storage manager 131 creates file management information 137 and sets “in fragments” on the allocation manner 1314 therein like in the step 911 (step 1105). In the step 1104, if it is determined that the record definition information 133 and the fragmentation definition information 134 do not exist for the file, the distributed memory storage manager 131 creates file management information 137 in the distributed memory storage and sets “normal” on the allocation manner 1314 like in the step 912 (step 1106). After these steps, each distributed memory storage access module 151 initializes the open file information 152 like in the step 913 (step 1107). Then, the step 1108 is executed that reports the end of the process to the UAP 161.

This file opening process enables a file preliminarily located in the distributed memory storage to be opened.

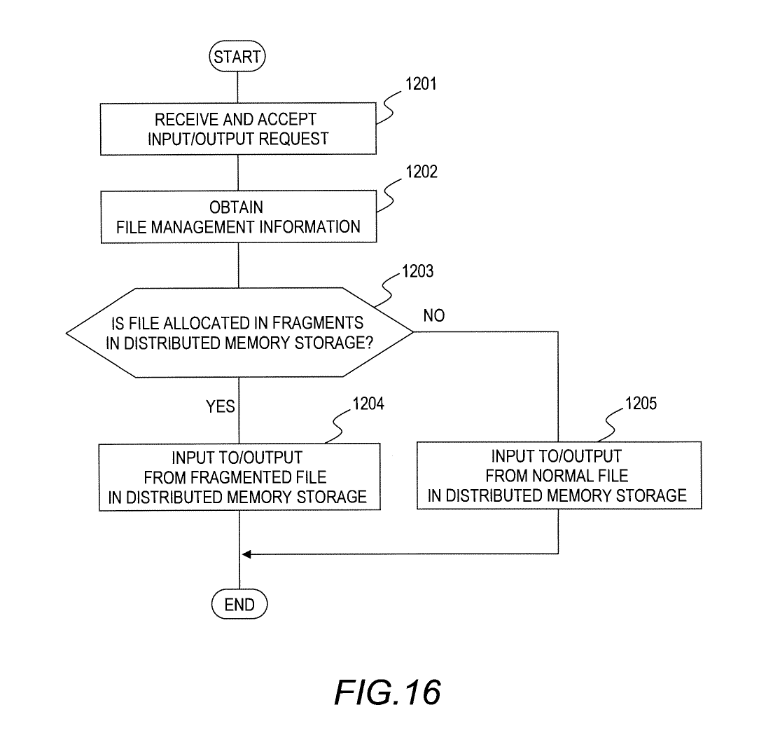

FIG. 16 is a flowchart illustrating an input/output process from/to a file allocated in the distributed memory storage. This process is executed in host computers 102 when the UAP 161 issues an input/output request as a trigger event after a process responsive to a file open request issued by the UAP 161 is finished.

When a distributed memory storage access module 151 receives an input/output request from the UAP 161 (step 1201), the UAP 161 requests file management information 137 about the access target file to the distributed memory storage manager 131 and obtains the file management information 137. In this regard, the file management information 137 may be the one which has been obtained in a prior input/output process and stored in a memory 114, or may be its copy which has been preliminarily transferred from the distributed memory storage manager 131 to the distributed memory storage access module 151 in an open process and stored in the memory 114 (step 1202).

The distributed memory storage access module 151 determines whether the target file of the input/output request is allocated in fragments in the distributed memory storage or not. This determination is made by whether the information set on the allocation manner 1314 in the file management information 137 is “in fragments” or “normal” (step 1203).

If the target file of the input/output request is allocated in fragments in the distributed memory storage, each distributed memory storage access module 151 executes an input/output process to/from the file allocated in fragments in the distributed memory storage, as will be described later, (step 1204). On the other hand, the target file of the input/output request is allocated in the normal mode in the distributed memory storage, each distributed memory storage access module 151 executes an inputs/output process to/from the file normally allocated in the distributed memory storage. This input/output process performed here is the same process as the input/output process in the normal file system, so the explanation is omitted in this description (step 1205).

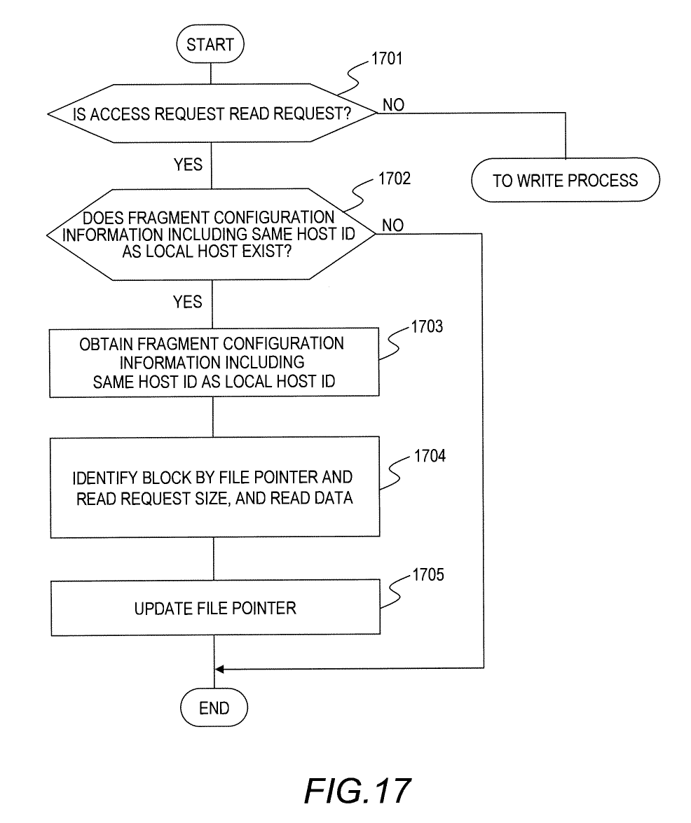

FIG. 17 is a flowchart illustrating a read process of data from a file allocated in fragments in the distributed memory storage. This process is executed in the step 1202 of FIG. 16, if the input/output request issued by the UAP 161 is a request to read a file allocated in fragments in the distributed memory storage.

If the input/output request issued by the UAP 161 is targeted to a file allocated in fragments in the distributed memory storage, the distributed memory storage access module 151 determines whether the input/output request is a request for reading data from a file or a request for writing data to a file. If the request is a write request, each distributed memory storage access module 151 executes a later-described write process (step 1701).

If the request is a read request, each distributed memory storage access module 151 refers to the host computer ID 1601 set on the fragment configuration information 1403 in the file management information 137 and determines whether the fragment configuration information 1403 exists or not that has the preset host computer ID 1601 of the local host computer (the host computer 102 executing the process). If the fragment configuration information 1403 exists, it means that a physical memory area 171 containing the file fragment to be accessed exists in the local computer and a file fragment to be read exists in the local host computer. If the fragment configuration information 1403 does not exist, the distributed memory storage access module 151 ends the process there (step 1702).

If the pertinent fragment configuration information 1403 exists, the distributed memory storage access module 151 obtains the fragment configuration information 1403 (step 1703). The distributed memory storage access module 151 locates the block containing the data to be read by the value of the file pointer 802 in open file information 142 and the read size designated by the access request and reads the data from the block (step 1704). Then, the distributed memory storage access module 151 updates the file pointer 802 in the open file information 142 and ends the read process. On this occasion, if the remaining size of the block where the data is read is not more than the size preset on the unused size 1605 in the block, the distributed memory storage access module 151 updates the file pointer so that it will indicate the beginning of the next block (step 1705).

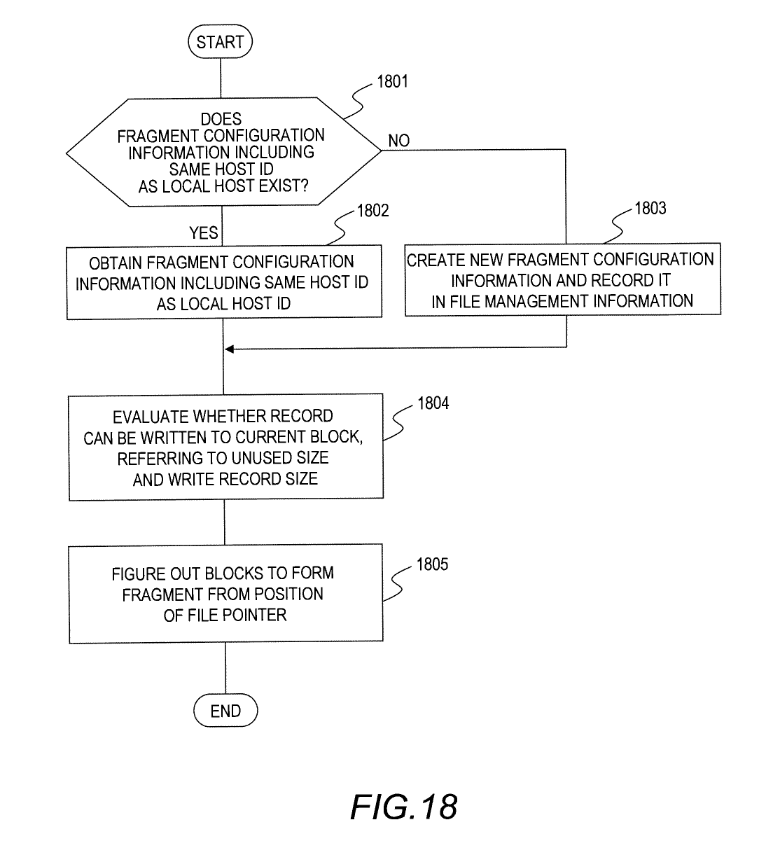

FIG. 18 is a flowchart illustrating a write process of data to a file allocated in fragments in the distributed memory storage. This process is a process to be executed at the step 1202 in FIG. 16 if the input/output request issued by the UAP 161 is a write request to a file allocated in fragments in the distributed memory storage, and is executed if it is determined that the access request is a write request in the step 1701.

If the input/output request issued by the UAP 161 is a write request to a file allocated in fragments in the distributed memory storage, each distributed memory storage access module 151 refers to the host computer ID 1601 set on the fragment configuration information 1403 in the file management information 137 and determines whether the fragment configuration information 1403 exists or not that has the preset host computer ID 1601 of the local host computer (the host computer 102 executing the process). If the fragment configuration information 1403 exists, it means that a physical memory area 171 containing the file fragment to be accessed exists in the local computer and a file fragment to be read exists in the local host computer (step 1801). If the fragment configuration information 1403 exists, the distributed memory storage access module 151 obtains the fragment configuration information 1403 (step 1802). If the fragment configuration information 1403 does not exist, the distributed memory access module 151 prepares a physical memory area 171 for storing a file fragment of the target file to write data and creates new fragment configuration information 1403. On this occasion, the identification information of the operating host computer 102 is set on the host computer ID 1601. The distributed memory storage access module 151 creates open file information 142 for the access target file and sets a value so that the file pointer 802 will indicate the beginning of the first block (step 1803).

Next, the distributed memory storage access module 151 evaluates whether or not it can write a record in the current block referring to the value of the file pointer 802 in the open file information 142 and the size of the record requested for write. If the record cannot be stored in the blocks following to the position pointed by the file pointer 802, the distributed memory storage access module 151 records the remaining volume of the block in the unused size of block 1605 and updates the value of the file pointer so that the file pointer 802 will point the beginning of the next block (step 1804). Then, the distributed memory storage access module 151 writes data of the record from the position indicated by the file pointer 802, updates the file pointer 802 so as to point the beginning of the next record, and ends the write process. If the file management information 137 is changed, the distributed memory storage access module 151 notifies the change to the distributed memory storage manager 131 and reflects the change to the file management information 137 owned by the distributed memory storage access module 151 (step 1805).

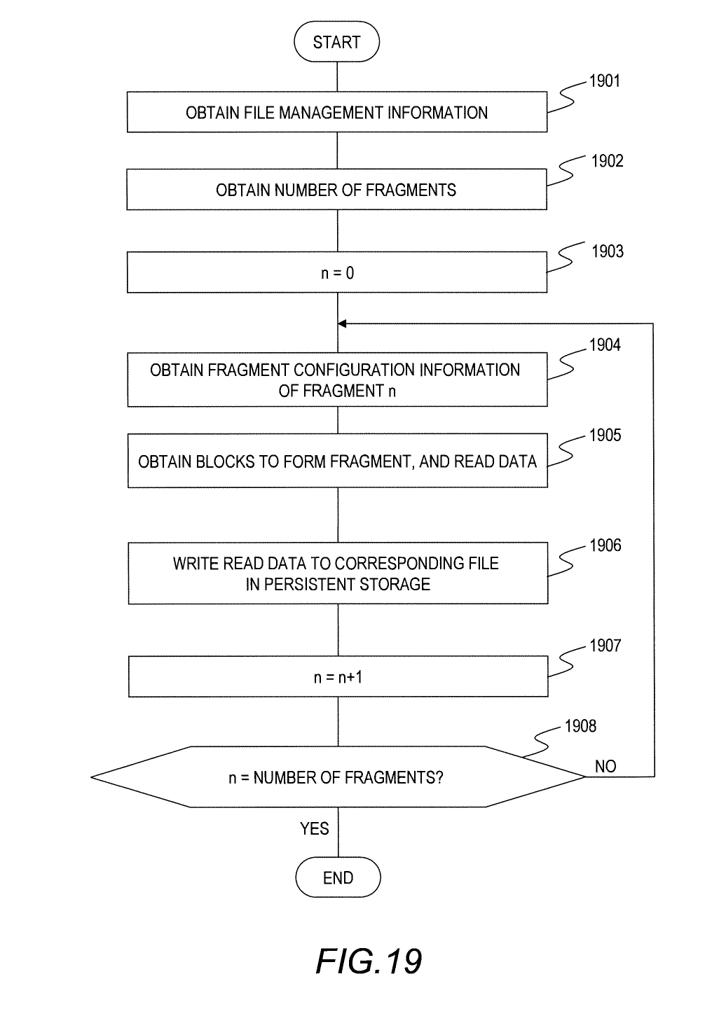

FIG. 19 is a flowchart illustrating a process of unloading a file allocated in fragments in the distributed memory storage. This process is executed by the distributed memory storage manager 131 when use of the file has been finished: for example, when the UAP 161 issues a request for closing the file or a declaration of end of use, which is a counterpart of a declaration of start of use in the push type file loading method, or when the file is kicked out of the distributed memory storage because of the LRU management for the distributed memory storage, for example.

The distributed memory storage manager 131 refers to the file management information 137 concerning the target file of the unloading (step 1901) and obtains the number of fragments 1401 set on the assignment information 1316 (step 1902). Then, to obtain fragment configuration information 1403 for each fragment of a divided file, it sets the loop variable n at 0 (step 1903).

Then, the distributed memory storage manager 131 obtains the fragment configuration information 1403 for the n-th fragment from the assignment information 1316 (step 1904). The distributed memory storage manager 131 obtains the file fragment stored in the physical memory area 171 in the host computer 102, which is identified by the host computer ID 1601 in the obtained fragment configuration information 1403, via the distributed memory storage access module 151 of the host computer 102 (step 1905). The file fragment obtained from the host computer 102 is written to the file in the storage device 103 which is indicated by the persistent storage and distributed memory storage association information 136 (step 1906).

Next, the distributed memory storage manager 131 adds 1 to the value n of the loop variable (step 1907). The distributed memory storage 131 compares the value n of the loop variable with the number of fragments obtained in the step 1902, and if they are the same, it ends the process. If the value n of the loop variable does not reach the number of fragments, the distributed memory storage manager 131 returns to the step 1904 and performs the same process to the next file fragment (step 1908).

As described above, according to the embodiment, in a computer system configured by a plurality of host computers, when caching a file to a distributed memory storage which is configured by integrating memories included in a plurality of host computers, the file is fragmented in accordance with a key of a record contained in the file and the file fragments are allocated in fragments in accordance with the key range into the memories in the host computers which constitute the distributed memory storage. Since each host computer can access each file fragment allocated in fragments with the original file name, existing programs without modification can operate in each host computers in parallel and higher processing speed can be accomplished.

What is claimed is:

1. A computer system comprising:
a storage device storing a file;
a plurality of application computers each comprising a processor for executing an application program which operates using data of the file and an access management program which receives a request for an access to data of the file from the application program and accesses the data of the file, and a memory device which is accessed by the processor; and
a management computer comprising a processor for executing a management program which divides an original file stored in the storage device and allocates the divided file to a distributed memory storage which is configured by integrating memory areas prepared in the memory devices in the plurality of application computers, and a memory device which is accessed to by the processor,
wherein the management program manages fragmentation definition information which indicates a manner of allocation of the data of the file to each of the memory areas which constitute the distributed memory storage and file management information for managing the state of allocation of the data of the file to the distributed memory storage, and allocates the data of the file stored in the storage device to the distributed memory storage in accordance with the fragmentation definition information,
wherein the plurality of application computers executes the application program and the access management program, and
wherein the plurality of application computers, by executing the access management program, receives an access to data of the file from the application program, obtains the file management information about the file to be accessed from the management program, and accesses the data allocated to the distributed memory storage on the basis of the file management information.

2. The computer system according to claim 1, wherein the fragmentation definition information includes:
allocation policy information for specifying a divide policy for the data of the file for allocation to the distributed memory storage;
the number of memory area information for indicating the number of memory areas in which the pieces of data of the divided file are allocated; and
key range information for indicating the range of the data of the divided file to be allocated to each of the memory areas.

3. The computer system according to claim 1, wherein the file management information includes:
allocation manner information for indicating whether the pieces of data of the divided file are divided and allocated to the distributed memory storage; and
identification information for identifying blocks in the memory areas included in the distributed memory storage in which the pieces of data of the divided file are allocated.

4. The computer system according to claim 3, wherein, in a case where the allocation manner information indicates that the pieces of data of the divided file are allocated to the distributed memory storage, the file management information includes, for each memory area where the pieces of data of the divided file is allocated, computer identification for identifying the application computer having the memory area, and the identification information for identifying the blocks.

5. The computer system according to claim 4, wherein the access management program manages file information including access mode information for indicating whether to access the divided file allocated to the distributed memory storage or to access allocated the original file and pointer information which indicates the memory area in the memory device which constitutes a part of the distributed memory storage and is to be accessed in accordance with an access request from the application program.

6. The computer system according to claim 5, wherein, in a case where the file is divided and allocated to the distributed memory storage, the file information managed by the access management program to be executed in each of the plurality of application computers includes pointer information which indicates an address in a divided part of the file allocated to the memory device in the application computer where the access management program operates.

7. The computer system according to claim 1, wherein the management program further manages association information for associating the file stored in the storage device and the distributed memory storage, and determines whether to allocate the data of the divided file to the distributed memory storage on the basis of the association information.

8. A method of executing an application program in a computer system comprising a storage device storing a file, a plurality of application computers each having a processor for executing the application program which operates using data of the file and an access management program which receives a request for an access to data of the file from the application program and accesses the data of the file and a memory device which is accessed by the processor, and a management computer having a processor for executing a management program which divides an original file stored in the storage device and allocates the divided file to a distributed memory storage which is configured by integrating memory areas prepared in the memory devices in the plurality of application computers, and a memory device which is referred to by the processor, the method comprising the steps of:
allocating, by the management program, the data of the file stored in the storage device to the memory areas which constitute the distributed memory storage in accordance with fragmentation definition information which is preset in the management computer and defines a manner of allocation of the data of the file stored in the storage device to each of the memory areas which constitute the distributed memory storage;
executing, by each of the plurality of application computers, the application program;
receiving, by the access management program, an access to data of the file from the application program;
obtaining, by the access management program, file management information about the file to be accessed from the management program; and
accessing, by the access management program, data allocated to the distributed memory storage on the basis of the file management information.

9. The method of executing an application program according to claim 8, wherein the allocating step includes the steps of:
receiving an open request for the file from the application program;
determining whether the file designated by the open request is to be allocated to the distributed memory storage by referring to association information for associating a file stored in the storage device and the distributed memory storage;
fragmenting the file designated by the open request in accordance with the fragmentation definition information, and allocating the file to the memory areas which constitute the distributed memory storage in a case where it is determined that the file designated by the open request is to be allocated to the distributed memory storage.

10. The method of executing an application program according to claim 9, wherein the allocating step includes the step of creating a file designated by the open request with reference to the fragmentation definition information in association with the file designated by the open request in a case where the file designated by the open request does not exist in the storage device.

11. The method of executing an application program according to claim 8,
wherein the file management information includes, with respect to each memory area included in each the plurality of application computers in which an associated file is divided and stored, fragmentation configuration information on which identifications of blocks in the memory area for storing the divided fragments of the associated file are preset, and
wherein in the accessing step includes the step of identifying a block in the memory area targeted for the access on the basis of the fragmentation configuration information.
